(19) United States
(12) Patent Application Publication
(10) Pub. No.: US 2025/0335390 A1
(43) Pub. Date: Oct. 30, 2025

(54) Bi-Directional Active USB Extension System with Auto Power and Data Role Configuration Capabilities

(71) Applicant: Legrand AV, Inc., Eden Prairie, MN (US)

(72) Inventors: Child Kuan-Leok Sun, Irvine, CA (US); Jennifer Dawn Crotinger, Tucson, AZ (US); Song Zeng, Dongguan (CN); Wenfang Wu, Dongguan (CN); Scott Lowder, Eden Prairie, MN (US)

(73) Assignee: Legrand AV, Inc., Eden Prairie, MN (US)

(21) Appl. No.: 19/186,263

(22) Filed: Apr. 22, 2025

Related U.S. Application Data
(60) Provisional application No. 63/639,439, filed on Apr. 26, 2024.

(51) Int. Cl. G06F 13/42; G06F 1/26; G06F 13/40; H01R 31/06

(52) U.S. Cl. CPC G06F 13/4282; G06F 1/266; G06F 13/4068; H01R 31/06; G06F 2213/0042

(57) ABSTRACT

A Universal Serial Bus (USB) power delivery system is provided that includes a first USB Type-C connector with a first converter circuitry and a second USB Type-C connector with a second converter circuitry. The first USB Type-C connector includes a first controller having a first electrical interface configured to electrically couple to a CC wire of the first USB Type-C connector, and to send/receive data via the first electrical interface and a first bi-directional voltage converter. The second converter circuitry includes a second controller having a second electrical interface configured to electrically couple to a CC wire of the second USB Type-C connector, and to send/receive data via the second electrical interface. A second bi-directional voltage converter includes an input and output, the second voltage converter receiving the second voltage at the input and outputting a third voltage at the output, thereby allowing power to flow in two directions.

### CROSS-REFERENCE TO RELATED APPLICATION

The present application claims priority benefit to a U.S. provisional patent application entitled “Bi-Directional Active USB Extension System with Auto Power and Data Role Configuration Capabilities,” filed on Apr. 26, 2024, and assigned Ser. No. 63/639,439. The entire content of the foregoing provisional patent application is incorporated herein by reference.

### BACKGROUND

Generally connecting USB devices together requires a cable. Generally, a USB cable for USB or USB applications is a passive piece of cable allowing for data and power to pass in a bi-directional manner for power and data transmission. However, because of the power and signal loss over electrical conductors, the maximum transmission distance is limited to just a few meters, if not less. To break the distance limit presented by the bare conductors, active power and signal extension schemes are needed. Since active extension is unidirectional in nature, special system architectures are proposed to maintain universality of active systems. In short, the present disclosure provides advantageous bi-directional active power/signal extension systems and methods.

### SUMMARY

In embodiments, a Universal Serial Bus (USB) power delivery system is provided that includes a first USB Type-C connector with a first converter circuitry. The first USB Type-C connector generally includes a first controller having a first electrical interface configured to electrically couple to a CC wire of the first USB Type-C connector. The first controller is generally configured to send and receive data via the first electrical interface and a first bi-directional voltage converter having an input and an output. The first voltage converter is generally configured to receive a first voltage at the input and to output a second voltage at the output. The first voltage converter is generally configured to allow power to flow in two directions. The input of the first voltage converter is configured to be electrically coupled to a V-bus wire of the first USB Type-C connector and the output of the first voltage converter is configured to be electrically coupled to a power transmission wire.

In embodiments, the Universal Serial Bus (USB) power delivery system also includes a second USB Type-C connector with a second converter circuitry, the second converter circuitry including a second controller having a second electrical interface configured to electrically couple to a CC wire of the second USB Type-C connector. The second controller is generally configured to send and receive data via the second electrical interface. A second bi-directional voltage converter is generally provided that includes an input and an output, the second voltage converter being configured to receive the second voltage at the input and to output a third voltage at the output, and allowing power to flow in two directions. The input of the second voltage converter is generally electrically coupled to the power transmission wire to electrically couple the first and second voltage converters and the output of the first voltage converter is configured to be electrically coupled to a V-bus wire of the second USB Type-C connector.

The first and second converter circuitry are electrically disposed between the first and second USB Type-C connectors. The first USB Type-C connector is generally configured to electrically couple to a first device and the second USB Type-C connector is generally configured to electrically couple to a second device to electrically interpose the first and second converter circuitry between the first and second devices to facilitate power delivery from the first device to the second device via the first and second converter circuitry.

Additional features, functions and benefits of the disclosed Universal Serial Bus (USB) power delivery system will be apparent from the description which follows, particularly when read in conjunction with the appended figures.

### BRIEF DESCRIPTION OF THE DRAWINGS

These and other features and advantages of the disclosed Universal Serial Bus (USB) power delivery system will be more fully understood by reference to the following detailed description in conjunction with the attached drawings in which like reference numerals refer to like elements throughout the different views.

FIG. 1 is a schematic of a Bi-directional Active USB Extension System with Auto Power and Data Role Configuration Capabilities;

FIG. 2 is a schematic of a data signal extender portion of a Bi-directional Active USB Extension System with Auto Power and Data Role Configuration Capabilities;

FIG. 3 is a block diagram of the signal extenders that transmit and receive information using optical interfaces;

FIG. 4 is a schematic of a transmit receive pair optically interfaced;

FIG. 5 is a block diagram of the signal extenders that transmit and receive information using electrical interfaces;

FIG. 6 is a block diagram of a transmit receive pair of a signal extender with an electrical interface;

FIG. 7 Is a block diagram of a power extender that connects the power from a first USB port to second USB port;

FIG. 8 is a functional block diagram of a power extender;

FIG. 9 is a block diagram of a control signal extender;

FIG. 10 is a Control Signal Extender example case of USB-A to -B extension with hardwiring for CS;

FIG. 11 is a schematic of a Bi-directional Active USB Extension System with Auto Power and Data Role Configuration Capabilities showing its partitioning;

FIGS. 12A-D show multiple form factors for housing an instance of converter circuitry; and

FIG. 13A-C show USB Extender cables using different form factor housings.

### DETAILED DESCRIPTION

In the following description of various example embodiments, reference is made to the accompanying drawings, which form a part hereof, and in which are shown by way of illustration various example devices, systems, and environments in which aspects of exemplary embodiments disclosed herein may be practiced. It is to be understood that other specific arrangements of parts, example devices, systems, and environments may be utilized and structural and functional modifications may be made without departing from the scope of the present disclosure. Like numbered call outs refer to identical components.

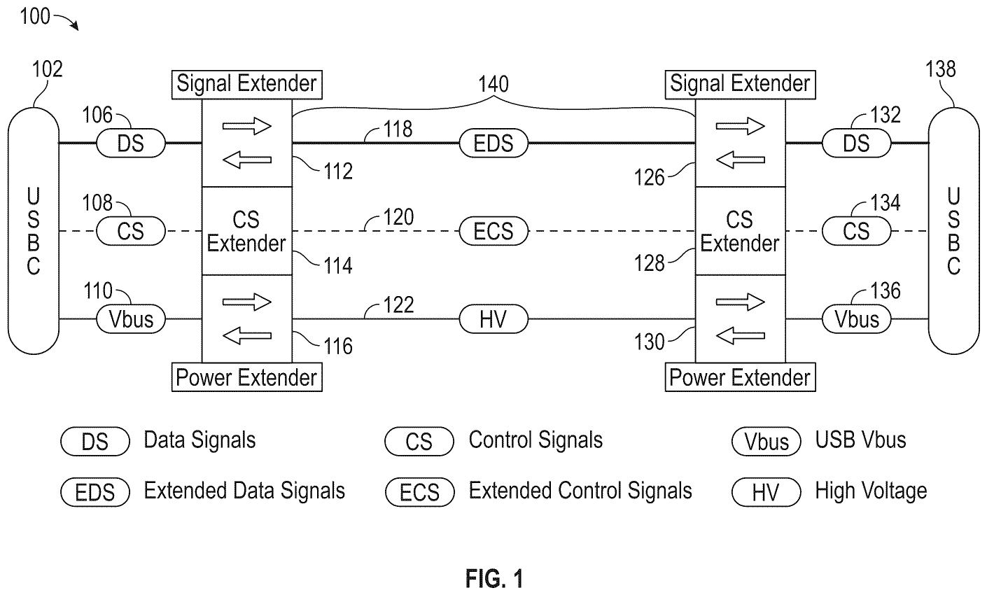

FIG. 1 is a schematic of a Bi-directional Active USB Extension System with Auto Power and Data Role Configuration Capabilities 100. The system includes a first USB port 102 that connects to a first device (not shown) and has a second USB port 138 that connects to a second device (not shown). The first USB port 102 receives/transmits data signals 106 that carry data to and from the first port. The first USB 102 port also receives/transmits control signals 108 used to control the configuration of a port with which it is connected. The first USB 102 port also includes power pins 110 that may supply power or take in power from another port.

The pins of the first USB port 102 are electrically coupled to a signal extender 112. Signal extender 112 electrically couples to the data signals 106 which in turn couple to external data signals 118. These signals may be buffered to drive these signals down a length of cable that are part of the extender. The control signals 108 from the first USB port are electrically coupled to a control signal extender 114 which in turn electrically couples the control signals 108 to the extended control signal signals 120. The control signal extender may buffer the control signals and is bi-directional. The USB V_{bus} 110 or power signals from the first USB port 102 are electrically coupled to a power extender 116 which is also bi-directional and couples the V_{bus} signals 110 to a high voltage line 122.

The power extender 116 is also bi-directional. It transmits power from USB port one V_{bus} 110 to the high voltage extender 116, thereby raising its voltage so that lower current is required for a particular power level. In that case, the power extender 116 is in “boost mode” as in an up converter. Power extender 116 can also take power from the high voltage extender at a higher voltage and reduce the voltage to couple to the V_{bus} 110. In that case, the power extender would be in “buck mode” as in down converter.

The extended data signals 118, extended control signals 120, and high voltage signals 122 make up the USB extender 140 that connects the first USB port to the second USB port. This cable connects the extenders 112, 114 and 116 to the extenders 126, 128 and 130. The cable generally includes appropriate shielding and contains appropriate creepage and clearance for higher voltage transmission.

The extended data signals 118 are electrically coupled to the signal extender 126 which is a bi-directional interface and in turn is electrically coupled to the second USB port 138 data signals 132. The extended control signals 120 are electrically coupled to the control signals extender 128 which in turn electrically couples to the control signals 134 of the USB Port 2 138. The high voltage signals 122 are electrically coupled to the power extender 130 which is bi-directional. The power extender 130 can take in power (122) at a high voltage and buck convert the voltage down to signal level for connection to the V_{bus} 136 of USB Port 2 138. The power extender 130 can also take power from V_{bus} 136 at a low voltage and boost convert it to a high voltage for transmission to the power extender 116 via 122. The bi-directional extension function can be implemented with LSI components or a mix of LSI or discrete components depending on the availability of the technologies.

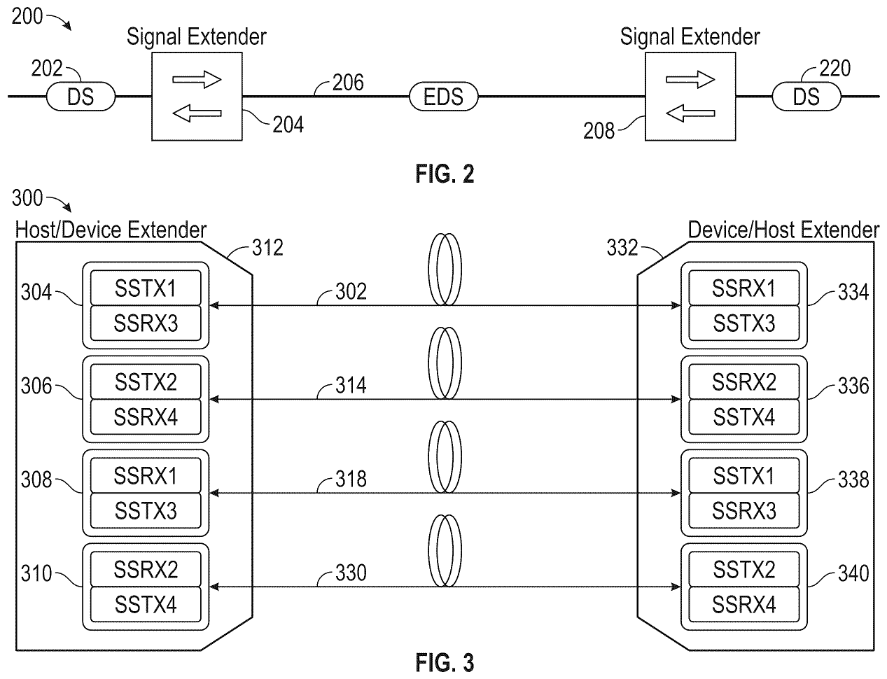

FIG. 2 is a schematic of a data signal extender portion of a Bi-directional Active USB Extension System with Auto Power and Data Role Configuration Capabilities 200. The data signal extender takes a data signal 202, which is from a first USB port (not shown) and electrically couples the data signals to a signal extender 204. The signal extender 204 is in turn electrically coupled to external data signals 206 which in turn is electrically coupled to the signal extender 208. The Signal extender 208 is electrically coupled to data signal 220. Data signal 220 is electrically coupled to a second USB port (not shown).

The signal extenders may be connected by the external data signals 206 via an optical interface. The extender 204 may convert the electrical data signals 202 to an optical signal. The extender 208 will also convert the optical signal back into an electrical signal. The signal extender 208 may take the electrical data signals 220, convert them to an optical format driving them back down 206. In this way, data is transferred bi-directionally from one USB port to another USB port optically, allowing highs speed interface over a long distance with a high degree of isolation from electrical interference.

The signal extenders 204 and 208 may be connected with an electrical interface. In this case, the signal extender 204 receives data from the data signal 202 and converts it to an appropriate electrical format for transmission to the signal extender 208 which in turn is electrically coupled to data signals 220. The data flow is bi-directional so that data signals 220 are converted to an appropriate electrical format and transmitted to the signal extender 204 which in turn electrically couples them to data signals 202. Data ports may be programmed to be an Upstream Facing Port at the host end or a Down Stream Facing Port at the device end.

The signal extenders 204 and 208 may be connected with a hybrid interface wherein part of the interface is electrical and part is optical. The USB 3.0 specification allows for a Super Speedy Interface which specifies data rates up to a 5 Gbps interface. The hybrid configuration may include an electrical interface wherein the D+/D− is driven electrically back and forth between the two USB ports while the Super Speedy Interface is optical.

FIG. 3 is a block diagram of signal extenders that transmit and receive information using optical interfaces 300. Extender 312 communicates with extender 332 optically and shows four transmit receive pairs, including a transmit receive pair 304 containing channel SSTX1 and SSRX3. This interface receives transmit pair 334 containing SSRX1 and SSTX3. Channel SSTX1 transmits information through optical channel 302 and drives receive channel SSRX1. Channel SSTX3 transmits information through optical channel 302 and drives receive channel SSRX3,

A transmit receive pair 306 contains channel SSTX2 and SSRX4. This interface receives transmit pair 336 containing SSRX2 and SSTX4. Channel SSTX2 transmits information through optical channel 314 and drives receive channel SSRX2. Channel SSTX4 transmits information through optical channel 314 and drives receive channel SSRX4.

A transmit receive pair 338 contains channel SSTX1 and SSRX3. This interface receives transmit pair 308 containing SSRX1 and SSTX3. Channel SSTX1 transmits information through optical channel 318 and drives receive channel SSRX1. Channel SSTX3 transmits information through optical channel 318 and drives receive channel SSRX3.

A transmit receive pair 340 contains channel SSTX2 and SSRX4. This interface receives transmit pair 310 containing SSRX2 and SSTX4. Channel SSTX2 transmits information optical channel 330 and drives receive channel SSRX2. Channel SSTX4 transmits information through optical channel 330 and drives receive channel SSRX4.

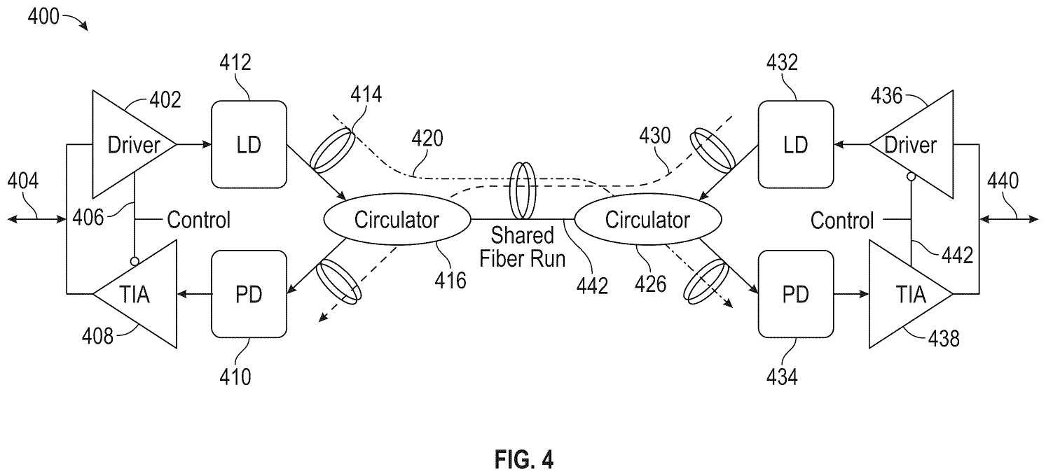

FIG. 4 is a schematic of a transmit receive pair optically interfaced 400 in finer detail. A bi-directional data input 404 is electrically coupled to a driver input 402 and a receiver 408 output. The driver output 402 is electrically coupled to a laser diode 412 which in turn drives an optical circulator 416 which transmits down a common fiber run 442. The shared fiber run 442 drives a circulator 426, which in turn drives the input to a PIN diode 434 converting the light signal to an electrical signal that is electrically coupled to driver 438 and which in turn is electrically coupled to a bi-directional data channel 440. Data from bi-directional data channel 440 is electrically coupled to a driver 436 input. The driver 436 output drives a laser diode 432. The laser diode converts the signal from electrical to optical. The laser diode 432 in turn drives a circulator 426 which drives a shared fiber run 442 and is coupled to circulator 416 which in turn drives a PIN diode 410 which converts the optical signal to an electrical signal which in turn is electrically coupled to the receiver 408. Receiver 408 is in turn electrically coupled to the bi-directional data channel 404.

The data flow in FIG. 4 is shown by line 420 and line 430. Data moves from the laser diode 412 output through circulators 416 and 426 to the PIN diode 434, which couples bi-directional data channel 404 to the bi-directional data channel 440. Data moves from bi-directional data channel 440 through the laser diode 432 through circulator 426 and 416 to drive PIN diode 410 and the driver receiver to bi-directional data channel 404. Drivers 402 and 408 are enabled by control input 406 and have complementary control inputs. When driver 402 is enabled, driver 408 is not, and when driver 408 is enabled, driver 402 is not. The same is true for drivers 436 and 438 which is controlled by control input 442. When driver 436 is enabled, driver 438 is not, and when driver 438 is enabled, driver 436 is not.

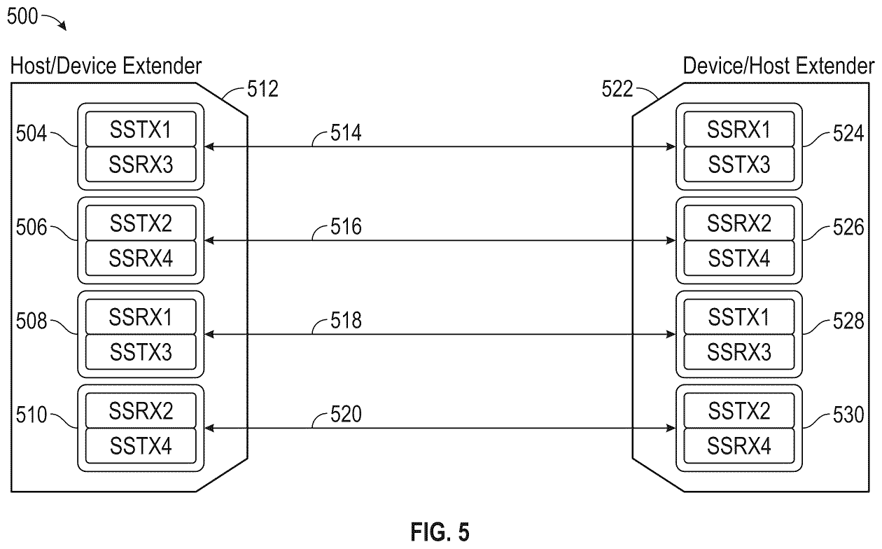

FIG. 5 is a block diagram of signal extenders 500 that transmit and receive information using electrical interfaces. Extender 512 communicates with extender 522 electrically and shows four transmit receive pairs. A transmit receive pair 504 contains channel SSTX1 and SSRX3. This interface receives transmit pair 524 containing SSRX1 and SSTX3. Channel SSTX1 transmits information down wires 514 and drives receive channel SSRX1. Channel SSTX3 transmits information down wires 514 and drives receive channel SSRX3.

A transmit receive pair 506 contains channel SSTX2 and SSRX4. This interface receives transmit pair 526 containing SSRX2 and SSTX4. Channel SSTX2 transmits information down wires 516 and drives receive channel SSRX2. Channel SSTX4 transmits information down wires 516 and drives receive channel SSRX4.

A transmit receive pair 528 contains channel SSTX1 and SSRX3. This interface receives transmit pair 508 containing SSRX1 and SSTX3. Channel SSTX1 transmits information down wires 518 and drives receive channel SSRX1. Channel SSTX3 transmits information down wires 518 and drives receive channel SSRX3.

A transmit receive pair 530 contains channel SSTX2 and SSRX4. This interface receives transmit pair 510 containing SSRX2 and SSTX4. Channel SSTX2 transmits information down wires 520 and drives receive channel SSRX2. Channel SSTX4 transmits information down wires 520 and drives receive channel SSRX4.

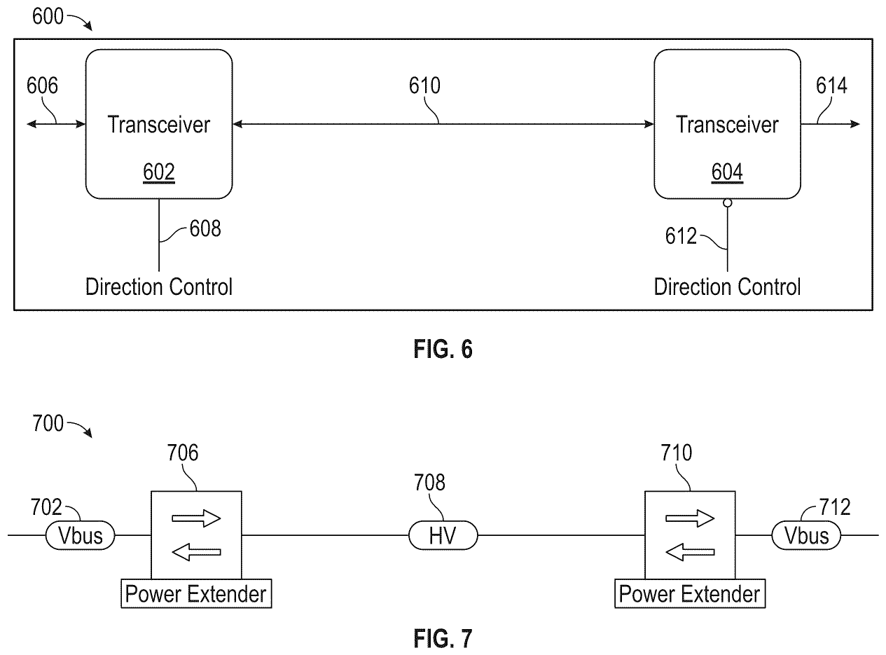

FIG. 6 is a block diagram 600 of a transmit receive pair of a signal extender with an electrical interface. A bi-directional data channel 606 is electrically coupled to a transceiver 602. The transceiver 602 is electrically coupled to interface channel 610. Interface channel 610 is electrically coupled to a transceiver 604. Transceiver 604 is electrically coupled to bi-directional data channel 614. Transceiver 602 may take data from bi-directional data channel 606 and drive interface channel 610, or it may take data from interface channel 610 and drive the bi-directional data channel 606. The direction of the data transfer is controlled by the signal 608. The transceiver 604 may take data from the interface channel 610 and drive the bi-directional data channel 614 or it may take data from the bi-directional data channel 614 and drive the interface channel 610. The direction of the data transfer for transceiver 610 is controlled by the control signal 612.

FIG. 7 is a block diagram of a power extender 700 that connects power from a first USB port to a second USB port. The power bus from a first USB port V bus 702 is electrically coupled to a power extender 706. The output of power extender 706 is electrically connected to a high voltage bus 708. The high voltage bus 708 is in turn electrically connected to a power extender 710. The power extender 710 is in turn connected to the power bus V bus 712 of a second USB port. The voltage of the first and second USB ports 702 and 712 is a low voltage, e.g., around 5 volts. The voltage of the high voltage bus 708 is a higher voltage and can be as high as 60 volts or even higher. The high voltage bus allows the transmission of power in either direction such that a lower current is needed to deliver a fixed power. Longer extenders may be used so that the 12R drop across the extender is significantly less. The power extenders 702 and 710 are bi-directional and can be set to deliver power from USB port 702 to USB port 712 or the reverse, i.e., from USB port 712 to USB port 702.

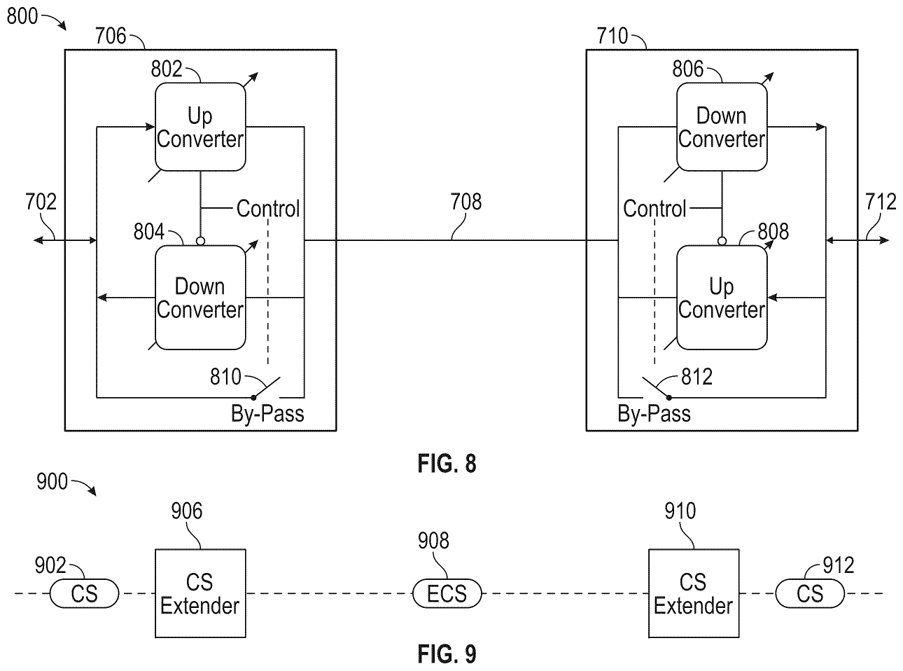

FIG. 8 is a functional block diagram 800 of a power extender 700. The power extender 706 is connected to the power 702 of a first USB port. The power 702 is electrically coupled to the input of an up converter 802. The output of the up converter 802 is connected to the high voltage bus. The input 702 is also connected to the output of a down converter 804. The input to the down converter 804 is also connected to the high power bus 708. The up converter 802, when enabled, converts the voltage input 702 to a higher voltage and outputs this higher voltage to the high voltage bus 708. The down converter, when enabled, converts the high voltage to a low voltage compatible with the USB power input V_{bus}. The power extender 706 can be bypassed so that the USB voltage can be directly coupled to the high voltage bus enabled by the control 810.

The power extender 710 also contains an up converter and a down converter. The high voltage bus 708 is electrically coupled with the input of the down converter 806 and is electrically coupled to the output of the up converter 808. The down converter 806 output is electrically coupled to the bus voltage V_{bus} of the second USB port and is also connected to the input of the up converter 808. The down converter takes power from the high voltage bus and reduces the voltage to a low voltage compatible with the USB voltage V_{bus}. The up converter takes power from the USB voltage bus V_{bus} and converts it to a high voltage so that it lowers the 12R losses for transmitting power down the extender. The down converter and up converter combination in the power extender 710 may be bypassed so the second USB port may have its power V_{bus} connected directly to the high voltage bus 708. The bypass is enabled by control signal 812. Both the power extender 706 and 710 are bi-directional. The power flow may be determined by the control input. In forward mode power flows from the first USB device to the second USB device. In reverse mode power flows from the second USB device to the first USB device. Forward mode and reverse mode is selected by the control input.

FIG. 9 is a block diagram of a control signal extender 900. The control signal 902 for the first USB port is electrically coupled to the control system extender 906. The control signal extender is electrically coupled to the extended control signal 908 which in turn is electrically coupled to the control signal extender 910. The control signal extender 910 is in turn electrically coupled to the control signals of the second USB port 912.

The control signal extender can detect and process the control signals from the system. The processed signals can be optionally forwarded to or exchanged with the remote ends to achieve the goals of role, direction, voltage level and configuration control. The transmission medium can be fiber or copper. It can also be carried over along the data channel if the design allows. A manual switch or hardwiring can be optionally used as a means of generating the required CS, such that the system's roles, directions, voltage levels and configurations can be set up accordingly. For the case of USB-C, CS can be derived from its CC channel.

Alternatively control information may be passed through the data channel. Control configuration may be passed directionally so that the control configuration may be transmitted from signal extender 112 to signal extender 126. Alternatively control configuration may be transmitted from signal extender 126 to signal extender 112. Appropriate logic may be used to facilitate the control configuration.

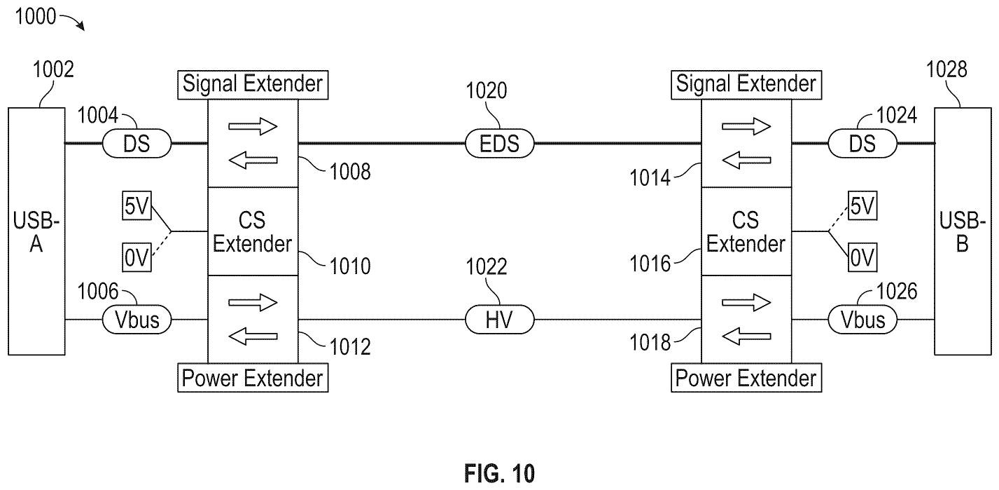

FIG. 10 is a Control Signal Extender example case of USB-A to -B extension with hardwiring for CS 1000. The block diagram shows a first USB-A port 1002 with data signals 1004 electrically coupled with a signal extender 1008. The signal extender 1008 is electrically coupled to an extended data signal bus 1020 which in turn is connected to a signal extender 1014. The data extender 1014 is in turn electrically coupled to data signals 1024 of USB-B port 1028. The USB-A 1002 power or V_{bus} 1006 is connected to the power extender 1012. Power extender 1012 is electrically coupled to a high voltage bus 1022 which is electrically coupled to a power extender 1018. The power extender 1018 is electrically coupled to the power V_{bus} 1026 of a power extender of the USB-B port 1028. The CS extender 1010 is switchable between 5 volt and 0 volt connections. Shown is the input electrically coupled to a 5 volt connection. The CS extender 1016 is also switchable to between 0 and 5 volt connections. Shown is the CS extender 1016 electrically coupled to the 0 volt connection. The CS Extender can detect and process the control signals from the system. The processed signals can be optionally forwarded to or exchanged with the remote ends to achieve the goals of role, direction, voltage level and configuration control.

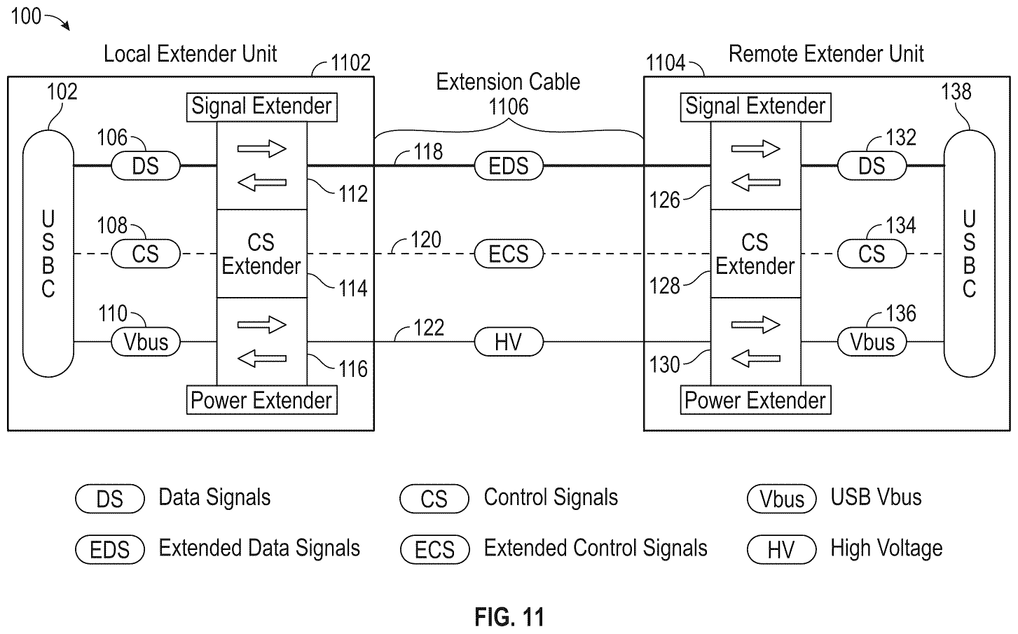

FIG. 11 is a schematic of a Bi-directional Active USB Extension System with Auto Power and Data Role Configuration Capabilities showing its partitioning 100. The extension system 100 is made of three parts. They comprise a local extender unit show in FIG. 11 as 1102. The local extender unit in this case contains the USB connector 102, the data signal 106, the control signals 108 and the V bus signal 110. The local extender unit also contains the signal extender 112, the control signal extender 114 and the power extender 116. The local signal extender makes up one end of the USB cable extender 100. The other end of the cable is the remote extender unit 1104. The remote extender unit 1104 contains the signal extender 126, the control signal extender 128 and the power extender 130. The remote extender unit also contains the data signals 132, the control signals 134, the power signals 136 and the USB connector 138. The local extender unit is physically connected to the remote extender unit by the extension cable 1106. In this case the extension cable is made up of the extended data signals 118, the extended control signals 120 and the high voltage signals 122. The local extender unit and the remote extender unit can be housed with different form factors.

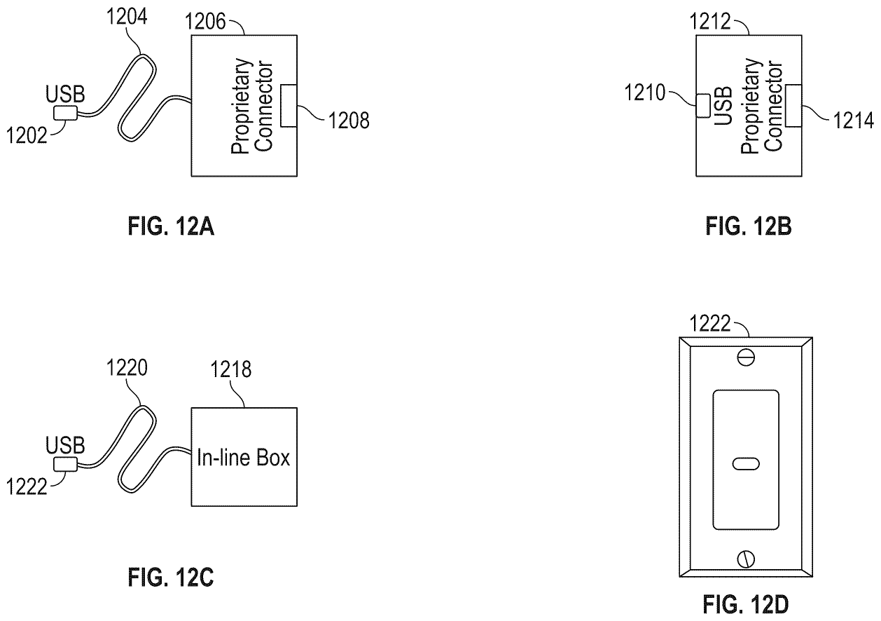

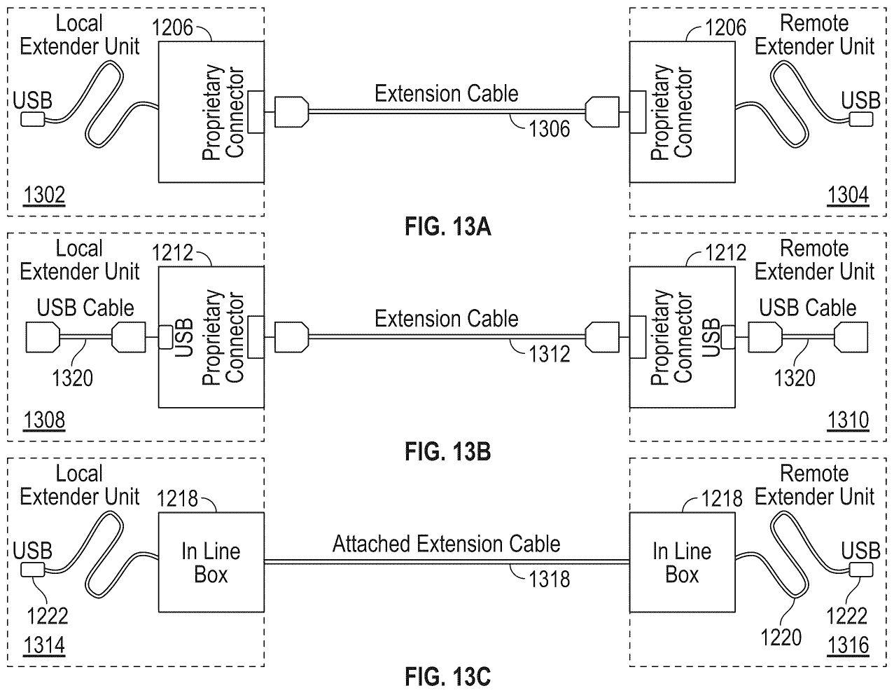

FIGS. 12A-D show multiple form factors for housing an instance of converter circuitry. FIG. 13A-C show USB Extender cables using different form factor housings. FIG. 12A shows an extender housing 1206 that can be configured as a local extender unit or a remote extender unit. The extender housing 1206 has a USB connector 1202 electrically coupled to a cable 1204 which in turn is electrically coupled to the extender housing 1206. The extender unit 1206 also has a proprietary connector 1208 which is used to connect the extender to an extension cable. FIG. 13A shows and extension cable that uses extender 1206 as a local extender unit 1302 and a remote extender unit 1304. The local extender unit 1302 is connected to the remote extender unit 1304 with an extension cable 1306.

FIG. 12 B shows an extender housing 1212 that has a USB connector 1210 and a proprietary connector 1214. FIG. 13 B shows an extender cable using housing 1212 as both a local extender unit 1308 and a remote extender unit 1310. The local extender unit 1308 is connected to the remote extender unit 1310 with an extension cable 1312. Each extender unit 1212 uses a USB cable 1320 to connect the extender 1212 to a device (not shown).

FIG. 12 C shows an extender housing 1218 that has a USB connector 1222 and cable 1220 and is also hard wired to interface the extension cable. FIG. 13 C shows an extension cable that is attached or hard wired coupling the Local extender unit 1314 and the remote extender unit 1316. The local extender unit 1314 includes the extender housing 1218, a USB connector 1222 and a cable 1220. The remote extender housing uses the extender housing 1218, a USB connector 1222 and a cable 1220. The local extender unit is connected to the remote extender unit by the attached extension cable 1318 via a hard wire connection.

FIG. 12 D shows an extender housing 1222 that can be wall mounted. It can be used as a local extender housing or a remote extender housing and can be configured in a similar manner to FIG. 13 B. The extender housing 1222 can replace the housing 1212.

1. A Universal Serial Bus (USB) power and data delivery system, comprising:
a first USB Type-C connector;
first converter circuitry, the first converter circuitry including:
a first controller having a first electrical interface configured to electrically couple to a CC wire of the first USB Type-C connector, the first controller being configured to send and receive data via the first electrical interface; and
a first bi-directional voltage converter having an input and an output, the first voltage converter being configured to receive a first voltage at the input and to output a second voltage at the output, and allowing power to flow in two directions, the input of the first voltage converter is configured to be electrically coupled to a V-bus wire of the first USB Type-C connector and the output of the first voltage converter is configured to be electrically coupled to a power transmission wire;
a second USB Type-C connector;
second converter circuitry, the second converter circuitry including:
a second controller having a second electrical interface configured to electrically couple to a CC wire of the second USB Type-C connector, the second controller being configured to send and receive data via the second electrical interface; and
a second bi-directional voltage converter having an input and an output, the second voltage converter being configured to receive the second voltage at the input and to output a third voltage at the output, and allowing power to flow in two directions, the input of the second voltage converter is electrically coupled to the power transmission wire to electrically couple the first and second voltage converters and the output of the first voltage converter is configured to be electrically coupled to a V-bus wire of the second USB Type-C connector,
wherein the first and second converter circuitry are electrically disposed between the first and second USB Type-C connectors, and
wherein the first USB Type-C connector is configured to electrically couple to a first device and the second USB Type-C connector is configured to electrically couple to a second device to electrically interpose the first and second converter circuitry between the first and second devices to facilitate power delivery from the first device to the second device via the first and second converter circuitry.

2. The USB power and data delivery system of claim 1, wherein the first electrical interface is bidirectional.

3. The USB power and data delivery system of claim 1, wherein the second electrical interface is bidirectional.

4. The USB power and data delivery system of claim 1, wherein the first electrical interface is connected to the second interface with a cable comprised of fiber optic.

5. The USB power and data delivery system of claim 1, wherein the first electrical interface is connected to the second interface with a cable comprised of copper.

6. The USB power and data delivery system of claim 1, wherein the first electrical interface is connected to the second interface with a cable comprised of a combination of fiber optic and copper wire.

7. The USB power and data delivery system of claim 1, wherein the first controller electrically couples the CC wire through a logic circuit to two different voltages.

8. The USB power and data delivery system of claim 1, wherein the second controller electrically couples the CC wire through a logic circuit to two different voltages.

9. The USB power and data delivery system of claim 1, wherein the first controller sends and receives data bidirectionally.

10. The USB power and data delivery system of claim 1, wherein the second controller sends and receives data bidirectionally.

11. A method of bi-directionally delivering power and data via a Universal Serial Bus (USB) cable, the method comprising:
in a forward mode:
receiving, by first converter circuitry, a first voltage and a first electrical current from a first device electrically coupled to the first converter circuitry via a V-bus wire associated with a first USB connector;
sending and receiving data through the first converter circuitry;
outputting, from the first converter circuitry, a second voltage and a second electrical current on a power transmission wire, the second voltage being greater than the first voltage and the second electrical current being less than the first electrical current;
receiving, by second converter circuitry, the second voltage and the second electrical current via the power transmission wire; and
outputting, from the second converter circuitry, a third voltage and a third electrical current to a second device via a V-bus wire associated with a second USB connector,
in a reverse mode:
receiving, by the second converter circuitry, a fourth voltage and a fourth electrical current from the second device electrically coupled to the second converter circuitry via the V-bus wire associated with the second USB connector;
sending and receiving data through the second converter circuitry;
outputting, from the second converter circuitry, a fifth voltage and a fifth electrical current on the power transmission wire, the fifth voltage being greater than the fourth voltage and the fifth electrical current being less than the fourth electrical current;
receiving, by first converter circuitry, the fifth voltage and the fifth electrical current via the power transmission wire; and
outputting, from the first converter circuitry, a sixth voltage and a sixth electrical current to the first device via the V-bus wire associated with the first USB connector,
wherein the first and second converter circuitry are electrically disposed between the first and second USB connector, and
wherein the first USB connector is configured to electrically couple to the first device and the second USB connector is configured to electrically couple to the second device to electrically interpose the first and second converter circuitry between the first and second devices to facilitate power delivery from the first device to the second device via the first and second converter circuitry in forward mode and to facilitate power delivery from the second device to the first device via the first and second converter circuitry in reverse mode.

12. The method of claim 11, wherein forward or reverse mode is asserted by a controller electrically coupled to the CC wire or to a logic circuit.

13. The method of claim 11, wherein the second voltage level is set by a controller.

14. The method of claim 11, wherein the fifth voltage level is set by a controller.

15. The method of claim 11, wherein the sending and receiving of data through the first converter circuitry is bidirectional.

16. The method of claim 11, wherein the sending and receiving of data through the second converter circuitry is bidirectional.
